(19) United States
(12) Patent Application Publication
(10) Pub. No.: US 2020/0310007 A1
(43) Pub. Date: Oct. 1, 2020

(54) LENS MODULE

(71) Applicant: HON HAI PRECISION INDUSTRY CO., LTD., New Taipei (TW)

(72) Inventors: YA-LAN FENG, New Taipei (TW); CHUN-CHENG KO, New Taipei (TW)

(21) Appl. No.: 16/743,194

(22) Filed: Jan. 15, 2020

(30) Foreign Application Priority Data
Mar. 29, 2019 (CN) 201910248378.6

(51) Int. Cl. G02B 5/00; G02B 13/18; G02B 1/11

(52) U.S. Cl. CPC G02B 5/003; G02B 1/11; G02B 13/18

(57) ABSTRACT

A lens module includes a lens barrel and a lens group including a number of lenses received in the lens barrel. Each of the lenses of the lens group includes a first surface facing an image side of the lens module. At least one of the lenses includes a blocking region on the first surface. The blocking region is coated with a light absorbing material.

### FIELD

The subject matter herein generally relates to lens modules, and more specifically to a lens module having an improved imaging function.

### BACKGROUND

More and more electronic devices come equipped with lens modules for imaging functions. However, when a lens module captures an image, light at a specific angle may enter an inner wall of a lens barrel of the lens module, and the light will be reflected and refracted by the lens barrel to an image sensor, which increases glare in the captured image.

### BRIEF DESCRIPTION OF THE DRAWINGS

Implementations of the present disclosure will now be described, by way of embodiments, with reference to the attached figures.

FIG. 1 is an assembled, isometric view of an embodiment of a lens module.

FIG. 2 is an exploded, isometric view of the lens module in FIG. 1.

FIG. 3 is similar to FIG. 2, but showing the lens module from another angle.

FIG. 4 is a cross-sectional view of the lens module in FIG. 1.

FIG. 5A shows a photo taken by a lens module in the related art.

FIG. 5B shows a photo taken by the lens module in the present disclosure.

FIG. 6 shows a blocking region of a lens of the lens module.

FIG. 7 is a close-up view of circled portion VII in FIG. 4.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

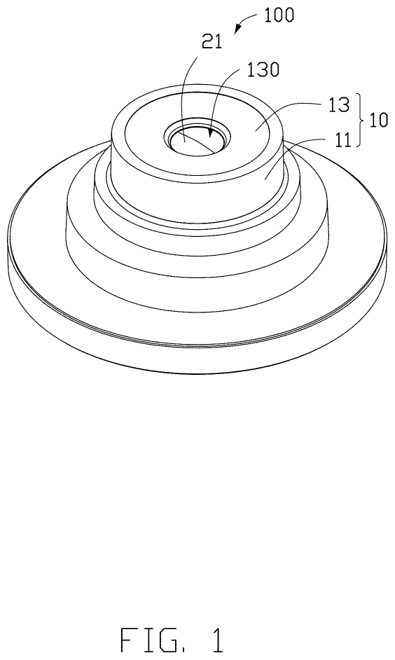

FIG. 1 shows an embodiment of a lens module 100 applicable in an electronic device, such as a mobile phone, a tablet computer, a notebook computer, or the like.

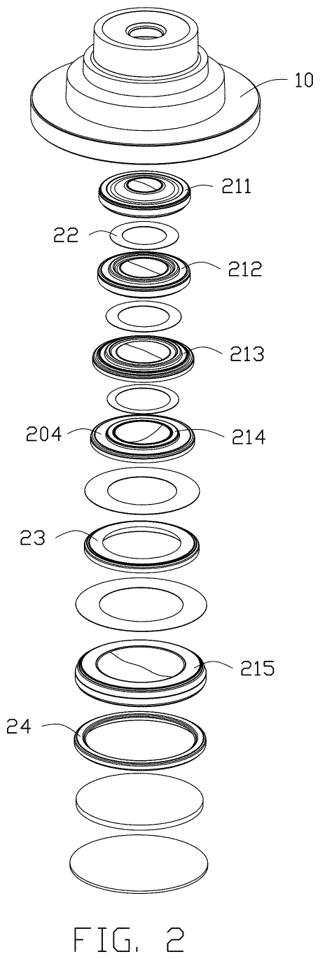

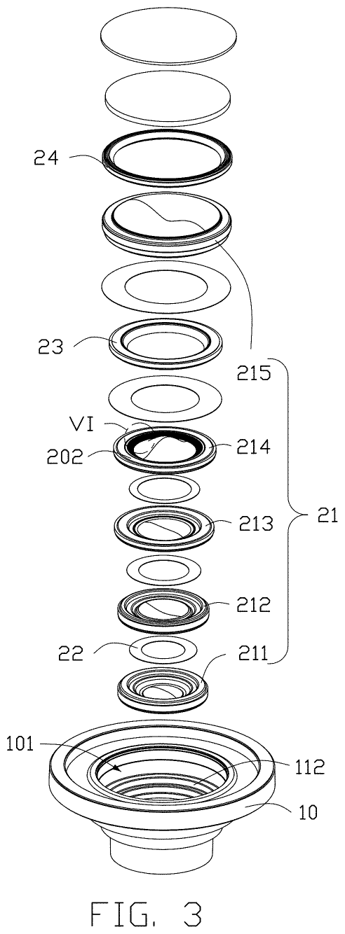

Referring to FIGS. 2 and 3, the lens module 100 includes a lens barrel 10, a lens group 21, a plurality of somas 22, a spacer 23, and a retainer 24. The lens group 21, the plurality of somas 22, the spacer 23, and the retainer 24 are located within the lens barrel 10.

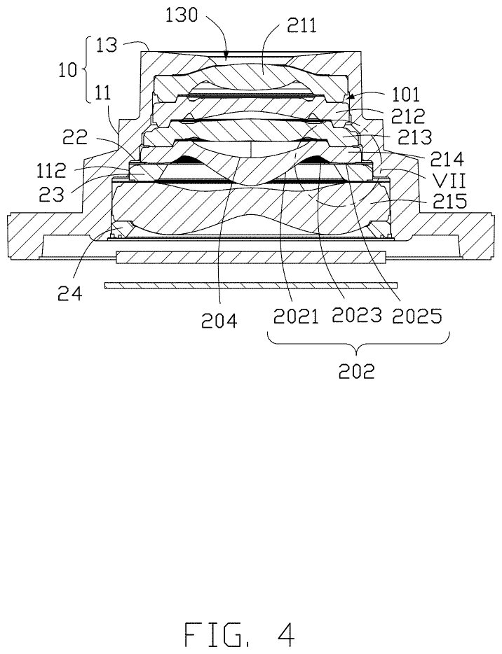

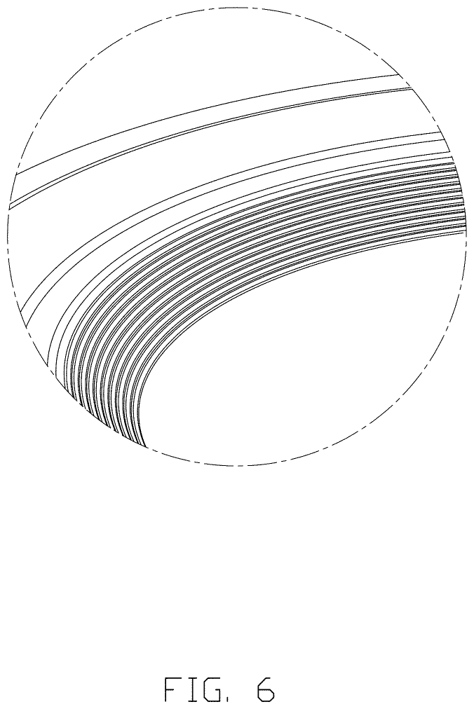

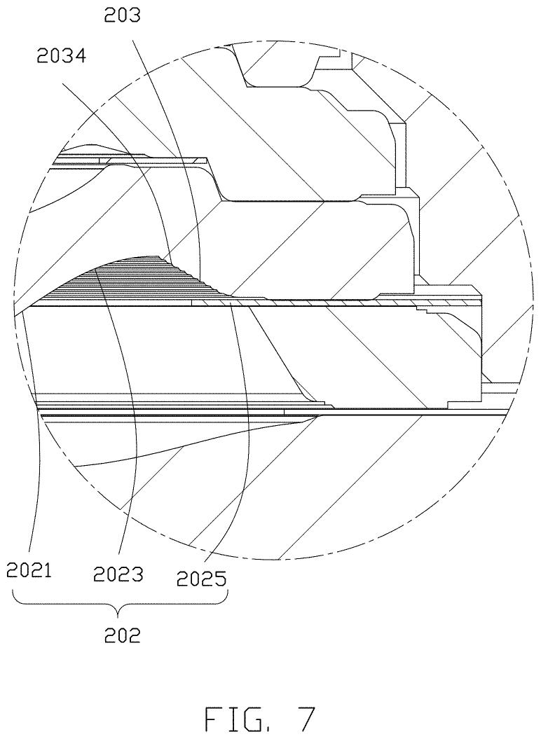

Referring to FIGS. 4, 6, and 7, each lens of the lens group 21 includes a first surface 202 facing an image side and a second surface 204 facing an object side of the lens module 100. The first surface 202 of at least one lens is provided with a blocking region 203. The blocking region 203 is annular and is located in a peripheral region of the first surface 202. An inner diameter of the blocking region 203 is greater than or equal to a light aperture of the lens 21. A light absorbing material is coated on the blocking region 203. The light absorbing material absorbs stray light.

In one embodiment, the blocking region 203 is provided with a plurality of densely arranged annular protrusions 2034. In one embodiment, a thickness of the light absorbing material ranges from 0.005 mm to 0.020 mm to avoid interference with other components and achieve a better light absorption effect.

The first surface 202 with the blocking region 203 is convex with respect to the image side. The first surface 202 includes a protruding portion 2021, an inclined portion 2023, and a supporting portion 2025. The protruding portion 2021 is located in a central area of the first surface 202. A middle portion of the protruding portion 2021 is convex toward the image side. The inclined portion 2023 is disposed around the protruding portion 2021. A side of the inclined portion 2023 away from the protruding portion 2021 is closer to the image side than a side of the inclined portion 2023 adjacent to the protruding portion 2021. The support portion 2025 surrounds the inclined portion 2023. The support portion 2025 is substantially flat and fixed between the lens barrel 10 and other lenses. The blocking region 203 is located on the inclined portion 2023.

The lens barrel 10 includes a peripheral wall 11 and a top wall 13 at one end of the peripheral wall 11. A receiving cavity 101 is cooperatively defined by the peripheral wall 11 and the top wall 13 for receiving the lens group 21, the plurality of somas 22, the spacer 23, and the retainer 24.

An end of the peripheral wall 11 opposite the top wall 13 is fixed on a circuit board (not shown) inside the electronic device. The top wall 13 is located outside the electronic device.

A light hole 130 is defined in the middle of the top wall 13. The light hole 130 communicates with the receiving cavity 101 for transmitting external light.

A plurality of annular protrusions 112 protrude from an inner surface of the peripheral wall 11. A distance that the protrusions 112 protrude toward a center of the lens barrel 10 gradually increases along a direction toward the top wall 13.

The lens group 21 includes a first lens 211, a second lens 212, a third lens 213, a fourth lens 214, and a fifth lens 215 which are sequentially stacked and received in the receiving cavity 101. The first lens 211 is located closest to the top wall 13. The blocking region 203 is on the fourth lens 214.

The spacer 23 is located between peripheral edge portions of the fourth lens 214 and the fifth lens 215 for maintaining a predetermined interval between the fourth lens 214 and the fifth lens 215.

The retainer 24 is adhered to a side of the fifth lens 215 facing the image side. The retainer 24 supports and fixes the lens group 21 and blocks light.

Each of the plurality of somas 22 is located between two adjacent lenses of the lens group 21 or between a lens and the spacer 23.

Each of the plurality of somas 22 is configured to block light from exiting from an edge of the lens group 21.

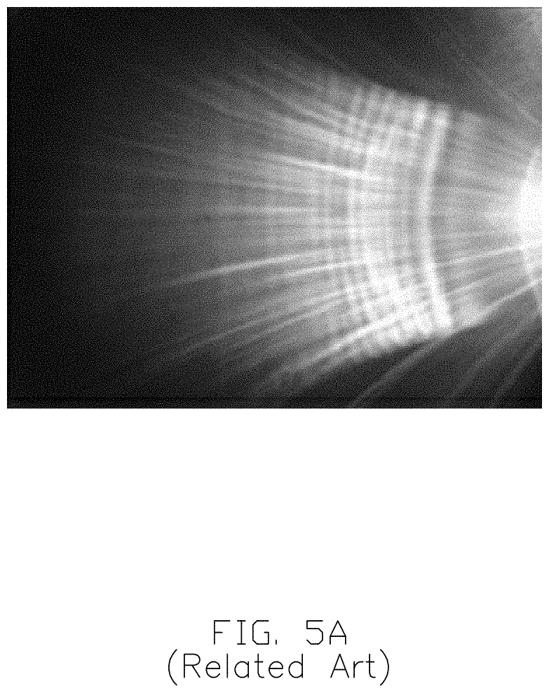

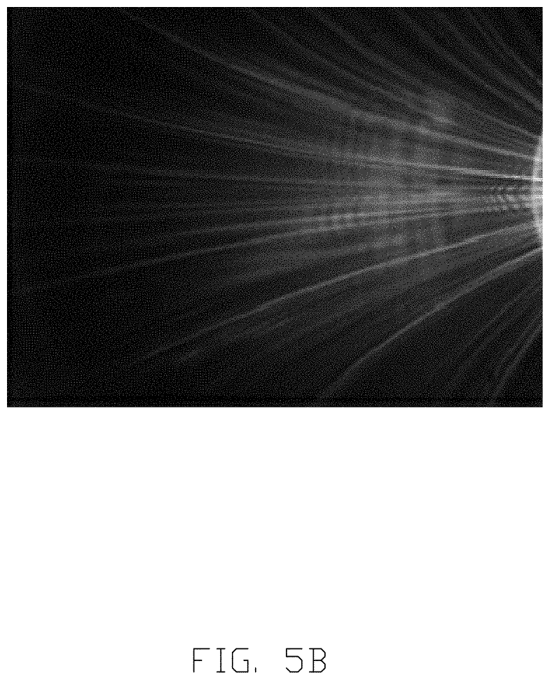

FIG. 5A is a photo taken by a lens module in the related art, and FIG. 5B is a photo taken by the lens module 100. It can be seen that the blocking region 203 in the lens module 100 absorbs light, thereby improving an image effect.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A lens module comprising:
a lens barrel; and
a lens group comprising a plurality of lenses received in the lens barrel; wherein:
each of the plurality of lenses of the lens group comprises a first surface facing an image side of the lens module;
at least one of the plurality of lenses comprises a blocking region on the first surface; and
the blocking region is coated with a light absorbing material.

2. The lens module of claim 1, wherein:
the blocking region is annular; and
an inner diameter of the blocking region is greater than a light aperture of the lens group.

3. The lens module of claim 2, wherein:
the blocking region comprises a plurality of annular protrusions.

4. The lens module of claim 1, wherein:
a thickness of the light absorbing material is between 0.005 mm to 0.020 mm.

5. The lens module of claim 1, wherein:
the first surface comprising the blocking region comprises a protruding portion, an inclined portion surrounding the protruding portion, and a supporting portion surrounding the inclined portion;
a middle portion of the protruding portion is convex toward the image side;
a side of the inclined portion away from the protruding portion is closer to the image side than a side of the inclined portion adjacent to the protruding portion; and
the blocking region is located on the inclined portion.

6. The lens module of claim 1, wherein:
the lens group comprises a first lens, a second lens, a third lens, a fourth lens, and a fifth lens sequentially stacked and received in the lens barrel;
the first lens is located closest to an object side of the lens module; and
the blocking region is located on the fourth lens.

7. The lens module of claim 1, further comprising at least one spacer, wherein:
the at least one spacer is located between two adjacent lenses of the lens group, the at least one spacer maintains a predetermined interval between the two lenses.

8. The lens module of claim 1, further comprising at least one soma, wherein:
the at least one soma is located between two adjacent lenses of the lens group.

9. A lens module applicable in an electronic device, the lens module comprising:
a lens barrel;
a lens group comprising a plurality of lenses received in the lens barrel; and
a plurality of somas, each of the plurality of somas located between two adjacent lenses of the lens group; wherein:
each of the plurality of lenses of the lens group comprises a first surface facing an image side of the lens module;
at least one of the plurality of lenses comprises a blocking region on the first surface; and
the blocking region is coated with a light absorbing material.

10. The lens module of claim 9, wherein:
the blocking region is annular; and
an inner diameter of the blocking region is greater than a light aperture of the lens group.

11. The lens module of claim 10, wherein:
the blocking region comprises a plurality of annular protrusions.

12. The lens module of claim 11, wherein:
the first surface comprising the blocking region comprises a protruding portion, an inclined portion surrounding the protruding portion, and a supporting portion surrounding the inclined portion;
a middle portion of the protruding portion is convex toward the image side;
a side of the inclined portion away from the protruding portion is closer to the image side than a side of the inclined portion adjacent to the protruding portion; and
the blocking region is located on the inclined portion.

13. The lens module of claim 12, wherein:
the lens group comprises a first lens, a second lens, a third lens, a fourth lens, and a fifth lens sequentially stacked and received in the lens barrel;
the first lens is located closest to an object side of the lens module; and
the blocking region is located on the fourth lens.

14. The lens group of claim 13, further comprising at least one spacer, wherein:
the at least one spacer is located between two adjacent lenses of the lens group, the at least one spacer maintains a predetermined interval between the two lenses.
